(19) United States
(12) Patent Application Publication
(10) Pub. No.: US 2005/0051010 A1
(43) Pub. Date: Mar. 10, 2005

(54) Cake stand cutter

(76) Inventor: Inez Michelle Lee, Memphis, TN (US)

Correspondence Address: Inez M. Lee, P.O. BOX 181290, Memphis, TN, 38181, US

(21) Appl. No.: 10/444,909

(22) Filed: Sep. 9, 2003

(51) Int. Cl. B26D 1/00; B26D 3/00; B26D 7/00

(52) U.S. Cl. 83/410.9; 83/932; 83/412; 83/35

(57) ABSTRACT

The lid does not move only the tray and the handle move. The blades and the handle are attached. The blades will drop into the grooves that are on the bottom of the tray. Turn the handle the blades will rotate tray clockwise so you can retrieve an individual slice from the sliding door.

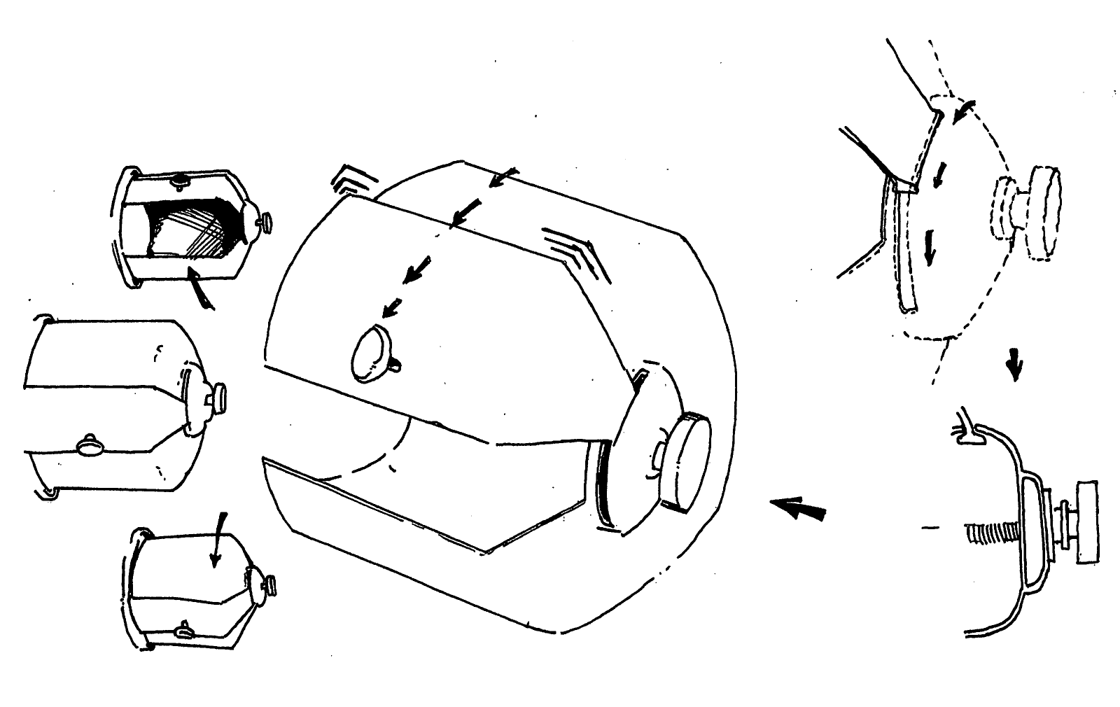

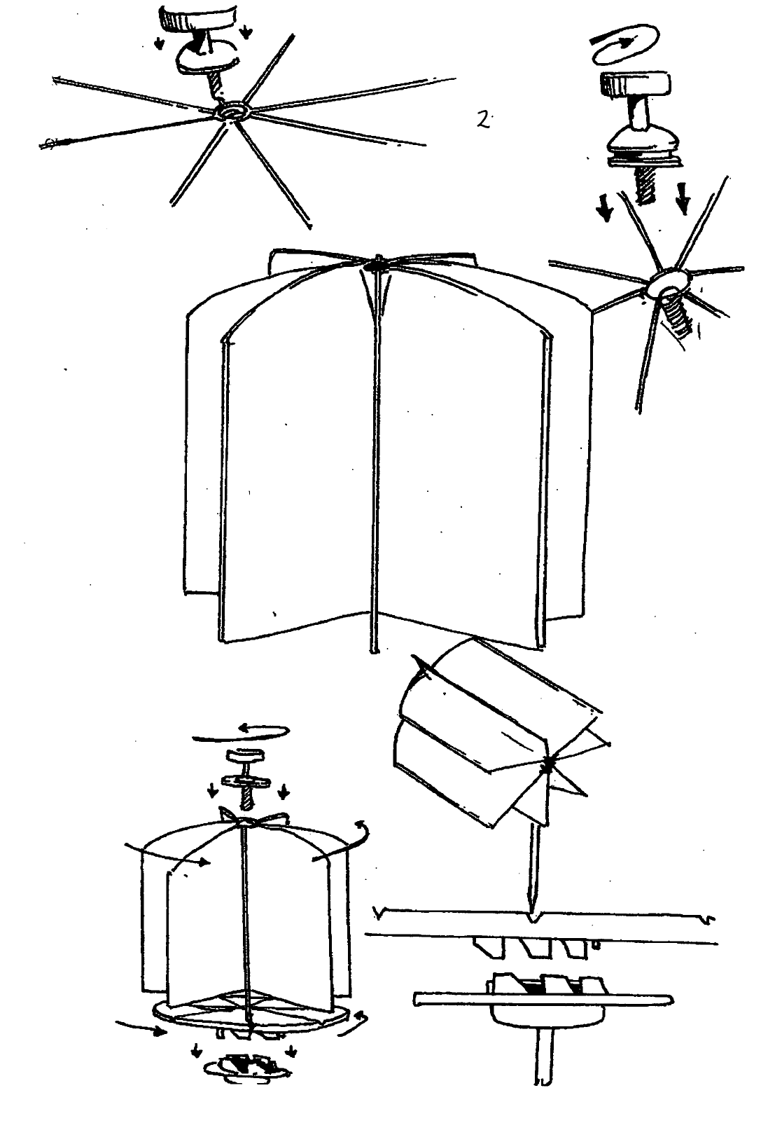

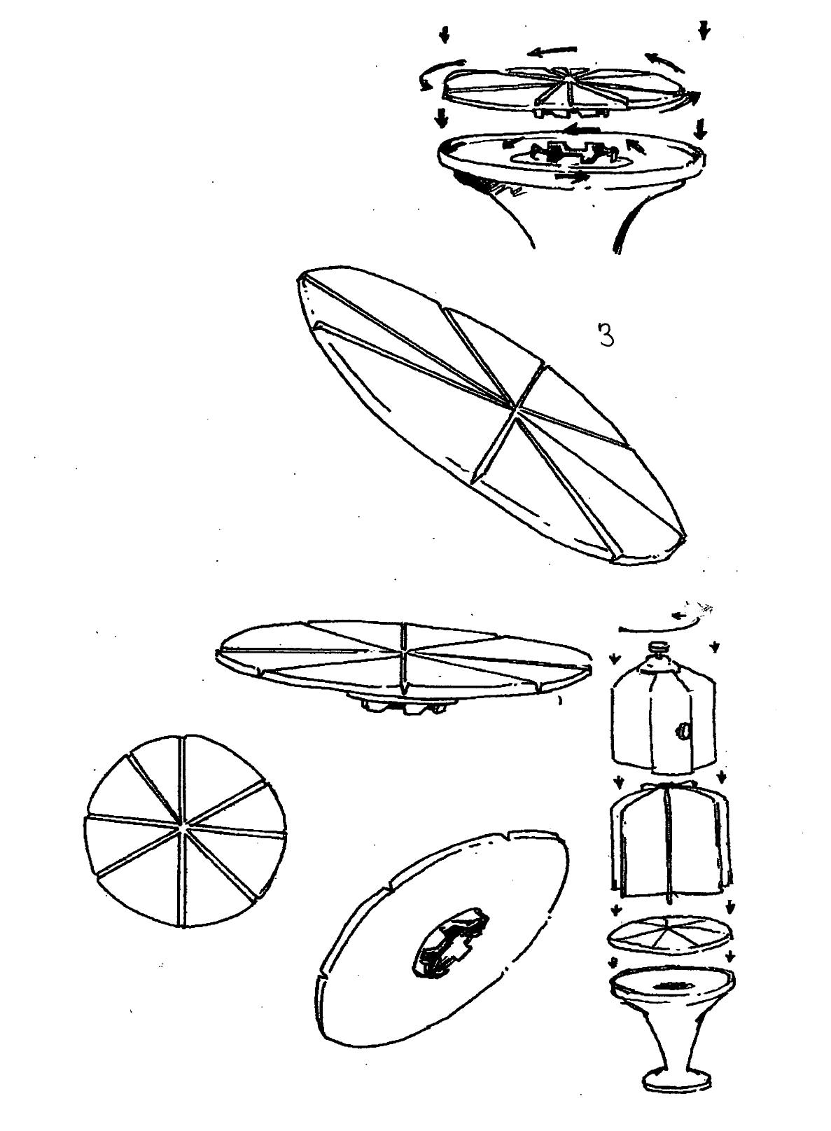

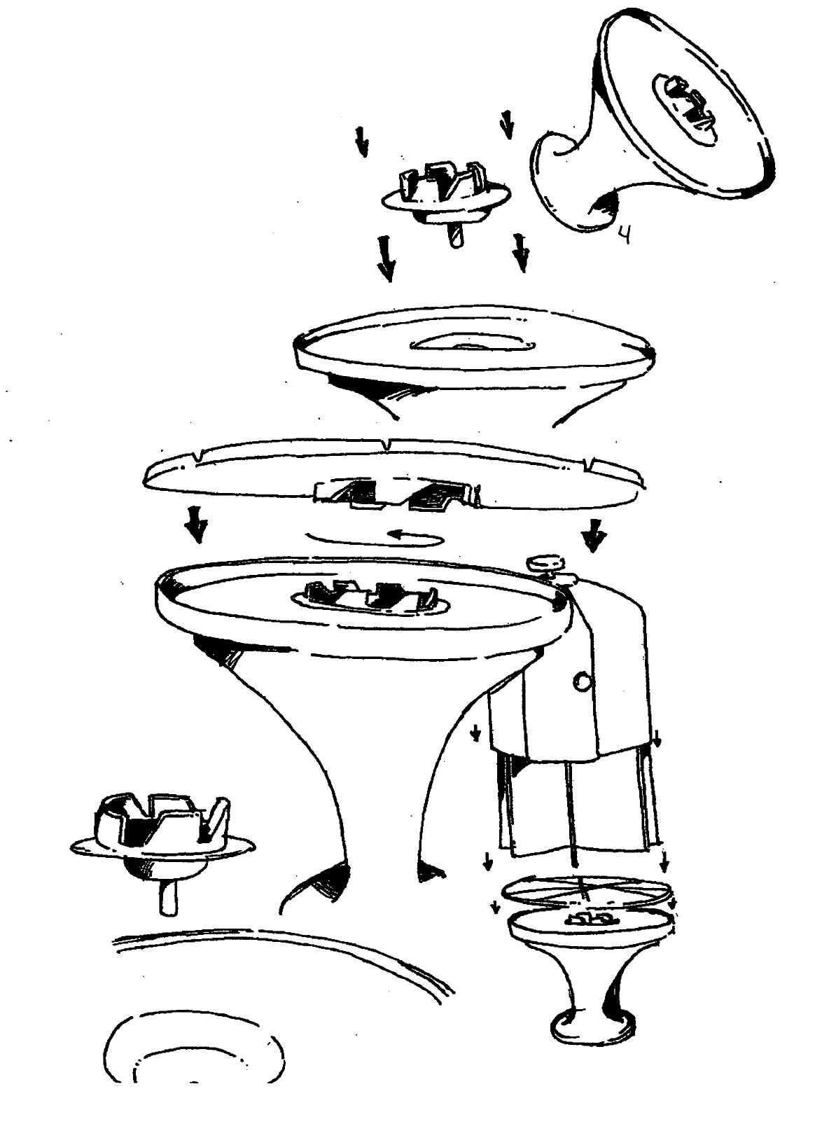

Standard size cake pan with a lid with built in cutters on a handle made for the rotating tray that's built onto the stand. In the side of the lid a sliding door is made so you can access your individual slice of cake.

### PRIMARY FUNCTIONS

To keep the cake moist. You will have perfect even slices every time without removing the lid.

### INSTRUCTIONS

After you put the cake on the cake stand close the lid down on the cake.

The cake is now cut In order to obtain additional slice turn the lids handle to the sliding door.

1. What I claim as my invention is the Cake Stand Cutter. It will be 12″×12″ It will be made out of crystal clear unbreakable polycarbonate plastic. The dome will be 7″½ in height. The blades or cutters will be 7″ to 7″½ to fit dome. Blades will be spaced 3″½ in width, sliding door on the dome will open 4″ to 4″½ in width. The pedestal will be approximately 4″½ in height with a built in rotating device. The pedestal's rotating tray will have 8 slice grooves a ½″ in width and ½″ in length. The Cake Stand Cutter will be a great product for chefs, restaurants, and general people because you have perfectly even slices without removing the lid which will keep the cake fresher longer. Also The Cake Stand Cutter will be a fresh new eye catching product that will make baking more convenient.
